(19) United States
(12) Patent Application Publication
(10) Pub. No.: US 2011/0138296 A1
(43) Pub. Date: Jun. 9, 2011

(54) METHOD AND DEVICE FOR BROWSING WEB PAGE SECURELY

(75) Inventors: Soon-back CHA, Hwaseong-si (KR); Si-jun LEE, Suwon-si (KR); Eun-hee RHIM, Suwon-si (KR)

(73) Assignee: SAMSUNG ELECTRONICS CO., LTD., Suwon-si (KR)

(21) Appl. No.: 12/912,063

(22) Filed: Oct. 26, 2010

(30) Foreign Application Priority Data
Dec. 9, 2009 (KR) 10-2009-0121932

(51) Int. Cl. G06F 3/01

(52) U.S. Cl. 715/741

(57) ABSTRACT

A method and device for browsing a web page in a terminal device are provided. The method includes generating a first value to verify whether the received web page is browsable using the terminal device, comparing the first value with a second value for the web page, the second value being received from a server and stored in the terminal device, and selectively browsing the web page based on the comparison result.

### CROSS-REFERENCE TO RELATED PATENT APPLICATION

This application claims priority from Korean Patent Application No. 10-2009-0121932, filed on Dec. 9, 2009, in the Korean Intellectual Property Office, the disclosure of which is herein incorporated by reference in its entirety.

### BACKGROUND

1. Field

Exemplary embodiments relate to a method and device for browsing a web page, and more particularly, to a method and device for securely browsing a web page in a terminal device with an internet function.

2. Description of the Related Art

Consumer electronic devices with a web browsing function for browsing web pages via the internet have become more generalized. The consumer electronic devices have limited hardware and software resources. Thus, occasionally, it may be difficult for consumer electronic devices to browse web pages that general purpose computers can browse. Additionally, a browsing request for unbrowsable web pages may cause a malfunction of the consumer electronic device.

### SUMMARY

Exemplary embodiments provide a method and device for securely browsing a web page in a terminal device with an internet function and also a computer readable recoding medium for performing the method.

According to an aspect, there is a method of browsing a web page in a terminal device, the method including receiving an execution request of an application for browsing the web page; receiving the web page by executing the application; generating a first value to verify whether the received web page is browsable by the terminal device; comparing the first value with a second value for the web page, the second value being received from a server and stored in the terminal device; and selectively browsing the web page based on the comparison result.

The first value may be a value generated by applying a hash function on data for the web page.

The method may further include receiving the application from the server and installing the received application before the execution request, wherein the application is a widget application.

The installing of the application may include receiving information about the widget application from the server; and storing the received information about the widget application, wherein the information about the widget application comprises at least one of a widget version, a widget name, a widget created data, a device model for executing a widget, and a uniform resource locator (URL) of a first execution web page of the widget application.

The information about the widget application may include the second value for the web page.

According to another aspect, there is provided a terminal device for browsing a web page, the device including an application management unit that receives an execution request of an application for browsing the web page and executing the application; a verify value generation unit that generates a first value to verify whether a web page received based on the application execution is browsable by the terminal device; a verify unit that compares the first value with a second value to determine whether the web page is browsable in the terminal device, the second value for the web page being received from a server and stored in the terminal device; and a browser that selectively browses the web page based on the determination result.

According to another aspect, there is provided a method of providing, from a server to a terminal device, an application for browsing a web page, the method including determining whether the web page is browsable by the terminal device; generating a first value about the web page if the web page is browsable by the terminal device; and transmitting the application and the first value to the terminal device.

According to another aspect, there is provided a server device for providing to a terminal device an application for browsing a web page, the server device including a verify unit that determines whether the web page is browsable by the terminal device; a verify value generation unit that generates a first value for the web page if the web page is browsable by the terminal device; and an application transmitting unit that transmits the application and the first value to the terminal device.

According to another aspect, there is provided a computer readable recoding medium for performing the method of browsing a web page and the method of providing an application.

### BRIEF DESCRIPTION OF THE DRAWINGS

The above and other aspects will become more apparent by describing in detail exemplary embodiments thereof with reference to the attached drawings in which:

FIG. 1 is a view illustrating a method of securely browsing a web page according to an exemplary embodiment;

FIG. 2 is a view illustrating an application server according to an exemplary embodiment;

FIG. 3 is a flowchart illustrating a method of verifying a web page by using an application server according to an exemplary embodiment;

FIG. 4 is a block diagram illustrating a terminal device according to an exemplary embodiment; and

FIG. 5 is a flowchart illustrating a method of securely browsing a web page in a terminal device according to an exemplary embodiment.

FIG. 6 is a flowchart illustrating a method of securely browsing a web page according to an exemplary embodiment.

### DETAILED DESCRIPTION

Hereinafter, exemplary embodiments will be described with reference to the drawings. In the drawings, like reference numbers refer to like elements, and also the size of each component may be exaggerated for clarity of illustration. Expressions such as “at least one of”, list when preceding a list of elements, modify the entire list of elements and do not modify the individual elements of the list.

FIG. 1 is a view illustrating a method of securely browsing a web page according to an exemplary embodiment.

Referring to FIG. 1, a terminal device 130 browses web pages 112, 114, and 116 of a web server 110. However, if the terminal device 130 does not include adequate hardware and software resources to browse web pages in a manner similar to general computers, the terminal device 130 may not see the web pages 112, 114, and 116 of the web server 110 as the web pages 112, 114, and 116 are supposed to be seen. In addition, if the terminal device 130 attempts to browse unbrowsable web pages, malfunctions may occur.

If the terminal device 130 is a consumer electronic device that is designed for a specific function, such as a TV, a DVD player, a settop-box, etc., the terminal device may not have enough hardware resources for browsing a web page and/or the capability of installing and updating software without difficulties. In such a case, it may be difficult for the terminal device 130 to fulfill a function for browsing a web page. Moreover, if a web page contains java script and cascading style sheets (CSS), for example, that require additional software such as a virtual machine or a plug-in, the java script and/or CSS may cause malfunction of the terminal device 130 during web browsing.

Accordingly, in order to avoid a malfunction caused by accessing a web page that the terminal device 130 cannot browse, the assistance of an application server 120 is used to verify a web page.

First, the terminal device 130 receives an application for browsing the web pages 112, 114, and 116 from the application server 120. The application from the application server 120 is executed in the terminal device 130 and may be a widget application for browsing the web pages 112, 114, and 116.

While browsing the web pages 112, 114, and 116, the terminal device 130 requests and receives an application from the application server 120 and also may install the received application in the terminal device 130 itself. Moreover, the terminal device 130 may receive the application from the application server 120 and may install the received application in advance. Thus, when a browsing request of the web pages 112, 114, and 116 is input by a user of the terminal device 130, the installed application may be executed.

Additionally, the application server 120 verifies that the web pages 112, 114, and 116 of the web server 110 can be browsed in the terminal device 130. For example, it may be determined that the web pages 112, 114, and 116 can be browsed if the terminal device 130 has previously browsed the web pages 112, 114, and 116 in a browsing environment of the terminal device 130. Alternatively, it may be determined also that the web pages 112, 114, and 116 can be browsed by verifying data for the web pages 112, 114, and 116 using test software, without web browsing. The test software may be predetermined.

If the web pages 112, 114, and 116 can be browsed in the terminal device 130, a verify value is generated based on data for a web page. A hash function may be applied on the data for a web page to generate a hash value. The hash function may be predetermined. At least one hash value is generated with respect to at least one of the web pages 112, 114, and 116, and then the generated hash values are matched with uniform resource locators (URLs) of the web pages 112, 114, and 116, respectively.

The terminal device 130 (that receives an application for web browsing from the application server 120 and information on whether a web page can be browsed through the application) requests at least one of the web pages 112, 114, and 116 from the web server 110, and then receives data for at least one of the web pages 112, 114, and 116 in response to the request.

A hash function is applied on the data for each of the received web pages 112, 114, and 116 to generate at least one hash value for each of the web pages 112, 114, and 116. For example, the terminal device 130 generates a hash value #1 for the web page #1 (112) and compares the hash value #1 with the information received from the application server 120. That is, by comparing the hash value corresponding to the URL of the web page #1 112 with the generated hash value #1, if the hash values are the same, it is determined that the web page #1 112 is not changed after the verification of the application server 120. Accordingly, it is determined whether the web page #1 (112) can be browsed by the terminal device 130. Thus, the terminal device 130 browses the web page #1 (112) using the application received from the application server 120.

The terminal device 130 generates hash values #2 and #3 with respect to the other web page #2 (114) and the web page #3 (116) through the same method, and then compares the generated hash values with hash values corresponding to the URLs of the web page #2 (114) and the web page #3 (116), respectively. Based on a comparison result, if the hash values are the same, it is determined that web page #2 (114) and the web page #3 (116) are not changed, and thus the terminal device 130 browses web page #2 (114) and the web page #3 (116) using the application.

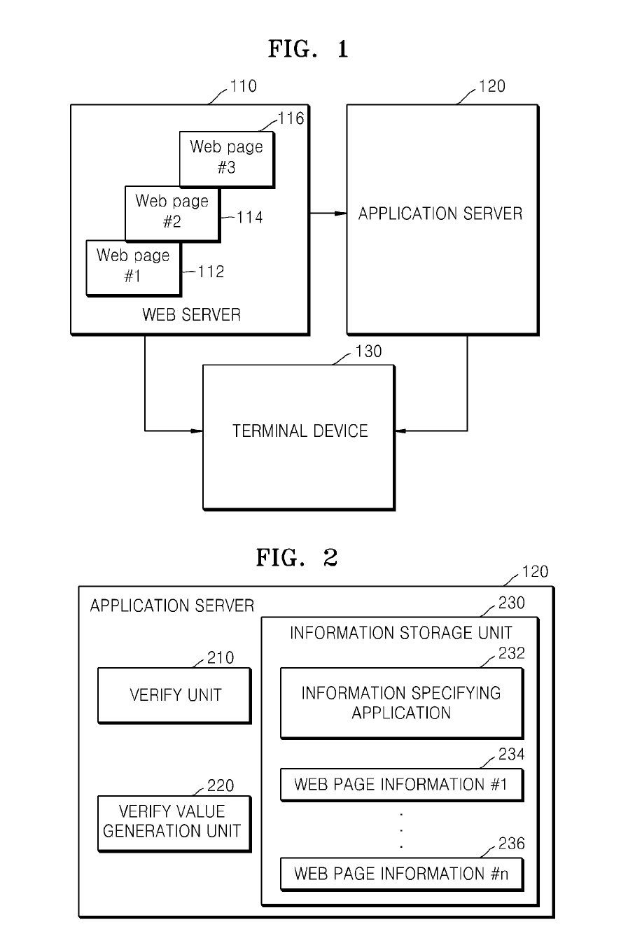

FIG. 2 is a view illustrating an application server according to an exemplary embodiment.

FIG. 2 illustrates the application server 120 for providing to the terminal device 130 an application for browsing a web page and information on whether a web page can be browsed by the application.

Referring to FIG. 2, the application server 120 includes a verify unit 210, a verify value generation unit, and an information storage unit 230.

The verify unit 210 verifies that at least one of the web pages 112, 114, and 116 of the web server 110 can be browsed by the terminal device 130. As mentioned above, data for the web pages 112, 114, and 116 are verified using a previous test for web browsing or using test software in a browsing environment of the terminal device 130. Then, it is determined whether the web pages 112, 114, and 116 can be browsed in the terminal device 130.

The verify value generation unit 220 generates a verify value for each of at least one of the web pages 112, 114, and 116, which are verified by the verify unit 210. Hash values are generated by applying a hash function to data for each of the web pages 112, 114, and 116. As mentioned above, a hash value #1 is generated by applying a predetermined hash function to data for the web page #1 (112). A hash value #2 is generated by applying a predetermined hash function to data for the web page #2 (114). A hash value #3 is generated by applying a hash function to data for the web page #3 (116). Each hash value is used for determining whether the web pages 112, 114, and 116 are changed after the verification, and then is stored in the information storage unit 230 (described later) in addition to the URLs of the web pages 112, 114, and 116.

The information storage unit 230 stores information about an application. As mentioned above, the application may be a widget application and the information storage unit 230 may store information about the widget application.

The information about a widget application includes a version of the widget application, a name, information about the creation of the widget application, an icon, a URL, a terminal model that can execute the widget application, and a first web page of the widget application, etc.

In addition, the information about a widget application may include information for at least one of the web pages 112, 114, and 116 that can be browsed by the terminal device 130 using the widget application. As mentioned above, the URLs of the web pages 112, 114, and 116 are matched with the hash values, respectively, and then the results of the hash value matching may be stored as information about the widget application.

Information 232 for specifying a widget application, and web page information #1 (234) and web page information #n (236) for at least one web page that the terminal device 130 can browse using a widget application are stored in the information storage unit 230. For example, web page information #1 (234) may take the format of Page URL: HashCode, in which the Page URL is the URL of the web page, and HashCode is the generated hash code for the web page. Therefore, the terminal device 130 receiving the widget application can access at least one of the verified web pages 112, 114, and 116. Although FIG. 2 depicts that web page information #1 (234) to web page information #n (236) are stored, this is only by way of example. It is sufficient if web page information for one web page is stored, or information for many web pages is stored.

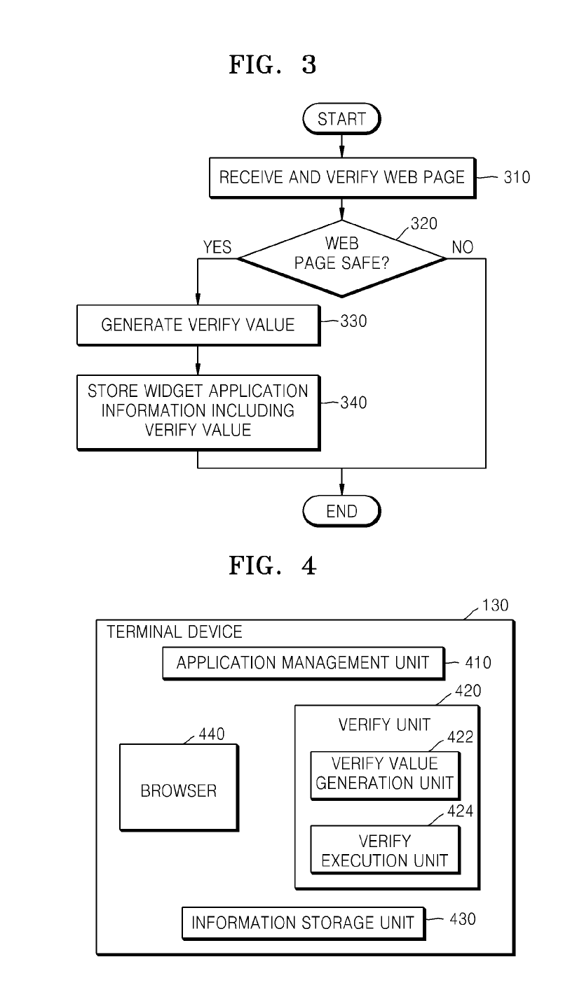

FIG. 3 is a flowchart illustrating a method of verifying a web page by using an application server according to an exemplary embodiment.

Referring to FIG. 3, the application server 120 receives at least one of the web pages 112, 114, and 116 and verifies at least one of the received web pages 112, 114, and 116 in operation 310. An exemplary verifying method is described above with reference to FIGS. 1 and 2.

In operation 320, the application server 120 determines whether at least one of the web pages 112, 114, and 116 is safe based on the verify result of operation 310. It is determined whether at least one of the web pages 112, 114, and 116 can be browsed by the terminal device 130 through an application. The application may be predetermined.

In operation 330, the application server 120 generates a verify value and stores the generated verify value. A verify value for each of the at least one of the web pages 112, 114, and 116 is generated and the generated verify value is stored. At least one verify value is generated by applying a hash function to data for each of the web pages 112, 114, and 116.

In operation 340, the application server 120 stores information for an application including the verify value generated in operation 340. Since information about a widget application can be stored, the stored information is stored in the information storage unit 230 described above with reference to FIG. 2.

FIG. 4 is a block diagram illustrating a terminal device according to an exemplary embodiment.

Referring to FIG. 4, the terminal device 130 includes an application management unit 410, a verify unit 420, an information storage unit 430, and a browser 440. The verify unit 420 includes a verify value generation unit 422 and a verify execution unit 424.

The application management unit 410 manages reception, installment, and update of an application for browsing a web page. The application management unit 410 receives an application for browsing a web page from an external server, installs the received application, and manages an update process of the installed application. Once a user requests browsing of a web page, the terminal device 130 requests an application from an external server and then installs the requested application. Alternatively, the terminal device 130 receives and installs an application from an external server in advance without a user request, and when a user requests browsing of a web page, the application can be executed through the browser 440. For example, the terminal device 130 may be set to automatically receive and install the application upon starting the terminal device 130.

The external server for providing an application may be the application server 120 or an additional server for storing application data. The terminal device 130 may receive information about a storage position (for example, a URL) of application data from the application server 120, and may request an application from an additional server based on the information about the received storage position.

The verify unit 420 receives at least one of the web pages 112, 114, and 116 that will be browsed in the browser 440, and generates a verify value with respect to each of the received web pages 112, 114, and 116.

The verify value generation unit 422 generates at least one hash value by applying a hash function to data for each of the web pages 112, 114, and 116. The same hash function used when the application server 120 generates a hash value is applied to generate at least one hash value with respect to each of the web pages 112, 114, and 116.

The verify execution unit 424 verifies whether at least one of the web pages 112, 114, and 116 is a web page that can be browsed by the browser 440, based on the at least one hash value generated by the verify value generation unit 422. At least one hash value with respect to each of at least one of the web pages 112, 114, and 116 stored in the information storage unit 430 is compared with at least one hash value generated by the verify value generation unit 422 in order to determine if the hash values are the same. If a URL of a web page stored in the information storage unit 430 is not identical to a URL of a web page (i.e., verification target), or if the URLs are the same but their hash values are different, it is determined that the web page is not verified.

The information storage unit 430 may store information about an application received from the application server 120. The URL and the hash value related to the URL are stored in the information storage unit 230 shown in FIG. 2. While URL information of at least one of the web pages 112, 114, and 116 and at least one hash value corresponding to each web page are stored, a hash value stored in the verify execution unit 424 is transmitted.

The browser 440 executes an application received from an external server to browse at least one of the web pages 112, 114, and 116. The application may be a widget application and browses at least one of the web pages 112, 114, and 116, which is listed in the stored information about a widget application of the information storage unit 430. Only at least one of the web pages 112, 114, and 116, verified by the verify unit 420, can be browsed.

The browser 440 requests and receives a first web page based on information about a widget application stored in the information storage unit 430. The received first web page is verified by the verify unit 420 and, only if the web page is verified, a widget application is used for browsing.

When a first web page is replaced by a second web page, a widget application is used for browsing only if the second web page is verified by the verify unit 420. Information 232, 234, and 236 about the above-mentioned widget application may include URLs of a plurality of web pages and a plurality of hash values corresponding to the URL, respectively. Accordingly, if information about a widget application includes a first web page, URLs of all browsable web pages, and a plurality of hash values corresponding to the URLs, respectively, the browser 440 verifies and browses the first web page and all browsable web pages using the verify unit 420.

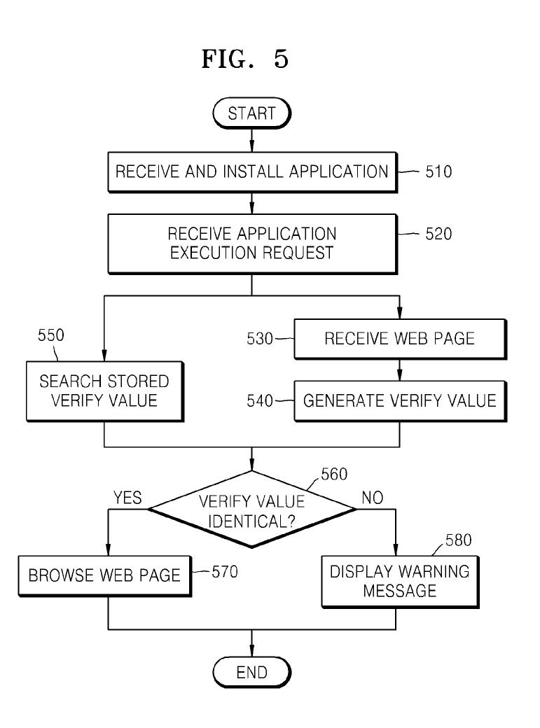

FIG. 5 is a flowchart illustrating a method of securely browsing a web page in a terminal device according to an exemplary embodiment.

Referring to FIG. 5, the terminal device 130 receives an application from an external server and installs the received application in operation 510. When a user requests browsing of a web page, the terminal device 130 may request an application from an external server and install the received application. Alternatively, without a user request, the terminal device 130 may request and install an application from an external server in advance. The application may be received from the application server 120 of FIG. 2, or may be received from an additional server storing application data. The application may be a widget application.

In operation 520, the terminal device 130 receives an execution request of the application in order to browse web pages. The request is received by an input device to the terminal device 130, and may be predetermined. The input device may be various devices such as a touch screen, a mouse, a touch button, a keyboard, etc., which may generate a signal by user movement.

In operation 530, the terminal device 130 receives a web page in response to the request in operation 520, from the web server 110. If the requested web page is not in a URL list of a web page included in information about a widget application, the terminal device 130 does not receive the web page and then may display a message indicating that an unverified web page has been requested.

In operation 540, the terminal device 130 generates a verify value about the web page received in operation 530. A hash function may be applied on the data about the web page received in operation 530 to generate a hash value.

In operation 550, the terminal device 130 searches a verify value about the web page requested in operation 520 from at least one of the verify values about at least one verified web page included in information received from the application server 120. The terminal device 130 searches a hash value corresponding to a URL of the web page requested in operation 520.

In operation 560, the terminal device 130 compares the verify value generated in operation 540 with the verify value searched in operation 550. If the two verify values are the same, it is determined that the web page requested in operation 520 is a verified web page and thus a web page can be browsed in operation 570. If the two verify values are different, it is determined that the web page requested in operation 520 is not a verified web page and thus a warning page is displayed to a user in operation 580. A warning message indicating that the requested web page is not a verified web page is displayed.

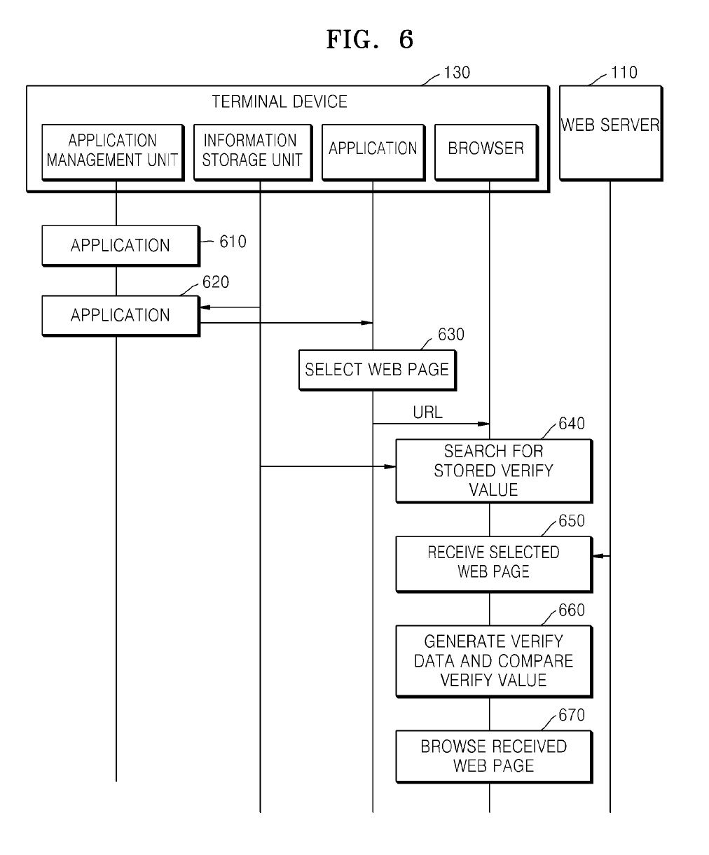

FIG. 6 is a flowchart illustrating a method of securely browsing a web page according to an exemplary embodiment.

Referring to FIG. 6, the terminal device 130 receives an application from an external server and installs the received application in operation 610. The application may be a widget application.

In operation 620, the terminal device 130 executes the application received in operation 610. The application is executed with reference to information about a widget application stored in the information storage unit 230.

In operation 630, a user selects a web page in an execution screen of the application.

In operation 640, the terminal device 130 searches a verify value about the web page selected in operation 630. The terminal device 130 searches information about a widget application stored in the information storage unit 230 and searches and locates a verify value about the web page selected in operation 630.

In operation 650, the terminal device 130 requests and receives the web page selected in operation 630, from the web server 110.

In operation 660, the terminal device 130 generates and compares a verify value about the web page received in operation 650. The verify unit 420 applies a hash function to data about a web page to generate a verify value, and then compares the generated verify value with the verify value searched in operation 640.

In operation 670, the terminal device 130 browses the web page received in operation 650. Based on the comparison result of operation 660, if the generated verify value and the searched verify value are the same, it is determined that the terminal device 130 can browse the web page through the browser 440.

Exemplary embodiments may be embodied in different forms and should not be construed as limited to the embodiments set forth herein. Rather, these embodiments are provided so that this disclosure will be thorough and complete, and will fully convey the scope to those skilled in the art. Accordingly, the present invention is only defined by scopes of claims and it is intended that the present invention covers the modifications and variations of this invention provided they come within the scope of the appended claims and their equivalents. The invention can also be embodied as computer readable codes on a computer readable recording medium.

For example, an application server and a terminal device according exemplary embodiments may include a bus connected to each of the plurality of units in the device shown in FIGS. 2 and 4, and at least one processor connected to the bus. Additionally, it may further include a memory that is connected to the bus in order to store a command, a received message, or a generated message, and also is connected to at least one processor for executing the above command.

The computer readable recording medium includes a computer readable storage medium and a computer readable transitory medium. The computer readable storage medium may be any data storage device that can store data which can be thereafter read by a computer system. Examples of the computer readable recording medium include read-only memory (ROM), random-access memory (RAM), CD-ROMs, magnetic tapes, floppy disks, and/or optical data storage devices. Examples of the computer readable transitory medium may be a carrier wave (such as data transmission through the Internet) or other such transmission. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope as defined by the following claims.

What is claimed is:

1. A method of browsing a web page using a terminal device, the method comprising:
receiving an execution request of an application for browsing the web page;
executing the application to receive the web page;
generating a first value to verify whether the received web page is browsable using the terminal device;
comparing the first value with a second value for the web page that is received from a server and stored in the terminal device; and
selectively browsing the web page based on a result of the comparing.

2. The method of claim 1, wherein the first value is a value generated by applying a hash function on data for the web page.

3. The method of claim 1, further comprising receiving the application from the server and installing the received application before the execution request, wherein the application is a widget application.

4. The method of claim 3, wherein the installing the received application comprises:
receiving information about the widget application from the server; and
storing the received information about the widget application,
wherein the information about the widget application comprises at least one of a widget version, a widget name, widget creation information, a device model for executing a widget, and a uniform resource locator (URL) of a first execution web page of the widget application.

5. The method of claim 4, wherein the information about the widget application comprises the second value for the web page.

6. A terminal device for browsing a web page, the terminal device comprising:
an application management unit that receives an execution request of an application for browsing the web page and executes the application;
a verify value generation unit that generates a first value to verify whether a web page received based on the application execution is browsable by the terminal device;
a verify unit that compares the first value with a second value to determine whether the web page is browsable by the terminal device, the second value for the web page being received from a server and stored in the terminal device; and
a browser that selectively browses the web page based on the determination result.

7. The device of claim 6, wherein the first is a value generated by applying a hash function on data for the web page.

8. The device of claim 6, wherein:
the application management unit receives the application from the server and installs the received application before the execution request; and
the application is a widget application.

9. The device of claim 8, wherein the application management unit receives information about the widget application from the server and stores the received information about the widget application,
wherein the information about the widget application comprises at least one of a widget version, a widget name, a widget created data, a device model for executing a widget, and a URL of a first execution web page of the widget application.

10. The device of claim 9, wherein the application information comprises the second value for the web page.

11. A method of providing, from a server to a terminal device, an application for browsing a web page, the method comprising:
determining whether the web page is browsable by the terminal device;
generating a first value about the web page if the web page is browsable by the terminal device; and
transmitting the application and the first value to the terminal device.

12. The method of claim 11, wherein the first value is a value generated by applying a hash function on data for the web page.

13. The method of claim 11, wherein:
the application is a widget application; and
the transmitting of the application and the first value comprises transmitting information about the widget application;
wherein the information about the widget application comprises at least one of a widget version, a widget name, a widget created data, a device model for executing a widget, and a URL of a first execution web page of the widget application.

14. A server device for providing an application for browsing a web page to a terminal device, the server device comprising:
a verify unit that determines whether the web page is browsable by the terminal device;
a verify value generation unit that generates a first value for the web page if the web page is browsable by the terminal device; and
an application transmitting unit that transmits the application and the first value to the terminal device.

15. The device of claim 14, wherein the first value is a value generated by applying a hash function on data for the web page.

16. The device of claim 14, wherein:
the application is a widget application;
the application transmitting unit transmits information about the widget application to the terminal device; and
the information about the widget application comprises at least one of a widget version, a widget name, a widget created data, a device model for executing a widget, and a uniform resource locator (URL) of a first execution web page of the widget application.

17. A computer readable recoding medium for performing a method comprising:
receiving an execution request of an application for browsing the web page;
executing the application to receive the web page;
generating a first value to verify whether the received web page is browsable using the terminal device;
comparing the first value with a second value for the web page that is received from a server and stored in the terminal device; and
selectively browsing the web page based on a result of the comparing.

18. A computer readable recoding medium for performing a method comprising:
determining whether the web page is browsable by the terminal device;
generating a first value about the web page if the web page is browsable by the terminal device; and
transmitting the application and the first value to the terminal device.

19. A method for browsing a web page using a terminal device, the method comprising:
receiving a widget application;
running the widget application to select a web page;
receiving web page data of the selected web page;
generating a first verify value for the received web page data;
searching for a second verify value for the received web page data;
comparing the first verify value and the second verify value; and
if the first and second verify values are the same, displaying the web page.
